(19) United States
(12) Patent Application Publication
(10) Pub. No.: US 2012/0258020 A1
(43) Pub. Date: Oct. 11, 2012

(54) MICRO CHANNEL REACTOR WITH INTEGRAL HEATING ELEMENTS

(76) Inventors: David O'Connor, North Bend, WA (US); Esmaeel Naeemi, Lynnwood, WA (US)

(21) Appl. No.: 13/442,694

(22) Filed: Apr. 9, 2012

Related U.S. Application Data
(60) Provisional application No. 61/472,920, filed on Apr. 7, 2011.

(51) Int. Cl. B01J 19/00

(52) U.S. Cl. 422/199

(57) ABSTRACT

In one example disclosed in the current application, by supplying just enough heat to the channel walls to replace the reaction heat removed during the reaction, a reactor exhibits tighter temperature tolerances with respect to the desired reaction temperature. In other words, the surface temperature can be more closely matched to the desired reaction temperature. Also, having a design where the channels can be scaled in both geometry and number allows control of the rate of mass transport through the channels to minimize unwanted side reactions.

### CROSS-REFERENCE TO RELATED APPLICATION

This application claims the benefit of Provisional Application No. 61/472,920, filed Apr. 7, 2011.

### TECHNICAL FIELD

The current application is directed to chemical reactors and, in a particular example, to a reactor in which a hydrogen carrier is heated to facilitate de-hydrogenation of the hydrogen-carrier.

### BACKGROUND

It is difficult to get heat and mass into the channels of a micro-channel reactor. There have been numerous designs where there is a heat source placed between the walls of the channels. The heat sources take up valuable space within the reactor. As the materials come in contact with the catalytic surfaces of the channels, the by-product may remove heat away from the walls and from the reactor. The individual channel design should accommodate both the reacted and unreacted materials while being able to move mass along the channel without side reactions occurring. Most designs scale the reactor to address mass-transport issues. Heat-transport issues are harder to address since most reactor designs have a single bulk heat source.

### SUMMARY

The current application is directed to supplying just enough heat to the channel walls to replace the reaction heat removed during the reaction, a reactor exhibits tighter temperature tolerances with respect to the desired reaction temperature. In other words, the surface temperature can be more closely matched to the desired reaction temperature. Also, having a design where the channels can be scaled in both geometry and number allows control of the rate of mass transport through the channels to minimize unwanted side reactions.

### BRIEF DESCRIPTION OF THE DRAWINGS

FIG. 1 illustrates resistance wire wound around the face surfaces of mica.

FIG. 2 illustrates a core section showing weld location and channel entrances.

FIG. 3 illustrates stacking of core sections for assembly.

FIGS. 4 illustrates a reactor core stack.

FIG. 5 shows cores removed to reveal bus bars and external electrical connections.

FIG. 6 shows a reactor with lid removed to reveal the cores.

FIG. 7 illustrates reactor-core sections with diffusion areas in between.

### DETAILED DESCRIPTION

### The Reactor Core

A flat piece of support material, mica in this case, is wound across its flat surfaces with resistance wire. Resistance wire material can be of different types, commonly known as Nichrome, Kanthal, Nikrothal, Chromel or any other material that has a voltage drop per unit length. The cross sectional geometries can also be round, as in this example, or may be square, rectangle, triangular or any other geometric shape. The use of different shapes might lend themselves to different flow characteristics within the channels. Different geometries of different types may change the flow from laminar to turbulent or vise versa.

Support materials can be anything that is chemically inert to the reactants, heat resistant at the desired operating temperatures, and that can act as an electrical insulator. Metals, such as aluminum with a hard aluminum oxide layer, can be used. Supports can be manufactured with oxide plating such that the underlying metal is protected and the outside surface is both chemically inert and non-electrically-conductive. A range of thickness of the oxide layers are can be employed.

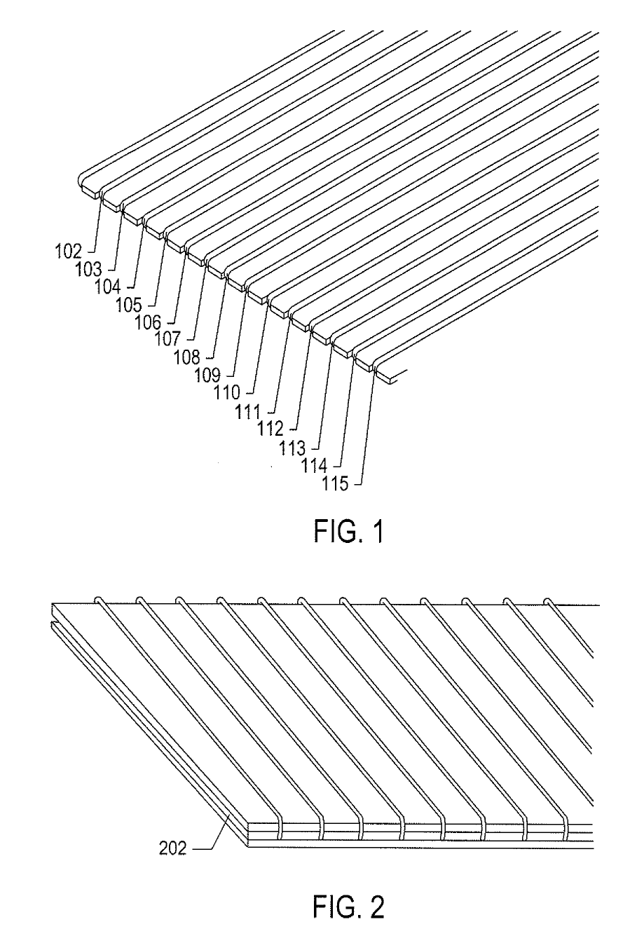

The wire-wound support material serves as a heater layer, as shown in FIG. 1. The windings 102-115 are parallel and evenly spaced (in one example, 0.030″ or 0.76 mm). The wire height is, in one example, 0.006″ or 35 AWG.

The windings perform two functions. First, they provide the heat source for the channels and second they provide the geometry of the channels. The support material surfaces of the heater layer are constructed and arranged, in one example, be both flat and parallel to each other. In this design, the edges of the support material that the wire is wound around have edge notches to keep wire aligned, as shown in FIG. 1.

### Winding:

The resistance wire is wound onto the support material, in one example, by first starting the winding in the middle of one edge and bringing the wire to an edge notch. The notches from one end to the other are offset by a predetermined amount, in one example. This amount is determined by calculation and or experimentation. It defines the channel width. Each winding, in one example, is parallel to its corresponding surface and diagonal to its edge defined by the number of winding for that specific face. The dimensions, direction and number of windings are defined by the CFD information for both heat transfer and mass flow through the channels. The angle of the diagonal winding is opposite, or a negative angle of same magnitude, on the opposite side. This propagates down the length of the support repeating itself until the end of the support. The final end exits the support at the middle but approaching from the opposite end as the start.

The windings can also be bifilar in nature where the winding of each of two wires occupies every other notch. This provides a second, redundant set of winds in case of malfunction. In certain examples, the current passed through the two windings may have opposite polarities which, in turn, can influence reactant molecules. A rapid interchange of polarities at a high frequency may further effect reactant molecules.

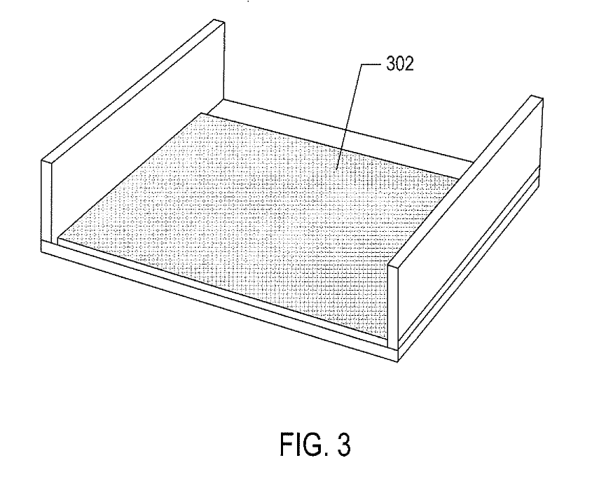

Once a heater layer is wound, the leading and trailing resistance wire ends are welded to bus bars. The wires ends are at either end of the support material. An insulating layer 202 is then placed on top of the now welded heater layer, as shown in FIG. 2. The insulating layer can be of the same material as the support material or may be another material that is non-conductive and chemically inert with respect to the hydrogen carrier and other reactant molecules.

A next heater/insulating layer 302 is then placed on top of the previous heater/insulating layer under pressure, shown in FIG. 3. Pressure is applied to ensure the new heater/ insulating layers are in contact with the underlying layers to minimize channel-to-channel leaking. This next heater/insulating layer is now welded to the bus bars. This process is repeated until the height of the active reactor is complete. A top end plate is then installed to maintain pressure and keep the layers from moving and coming apart. This also keeps the wound wires from moving while other layers are applied, thus maintaining the overall geometry of the channels.

The heater/insulating layers can be aligned within the stack by a number of different mechanisms. One alignment technique is through the use of pins that penetrate each of the layers. Another can be by notches milled into each of the two bus bars. Yet another involves using precision end effectors of an automated assembly mechanism and then performing the welding. In this design the layers are constrained on four sides. The two bus bars constrain the layers from moving in a side-to-side motion while the welding of the resistance wires constrains the layers from moving in a front-to-back motion. Pressure from the assembly process keeps tension on all layers.

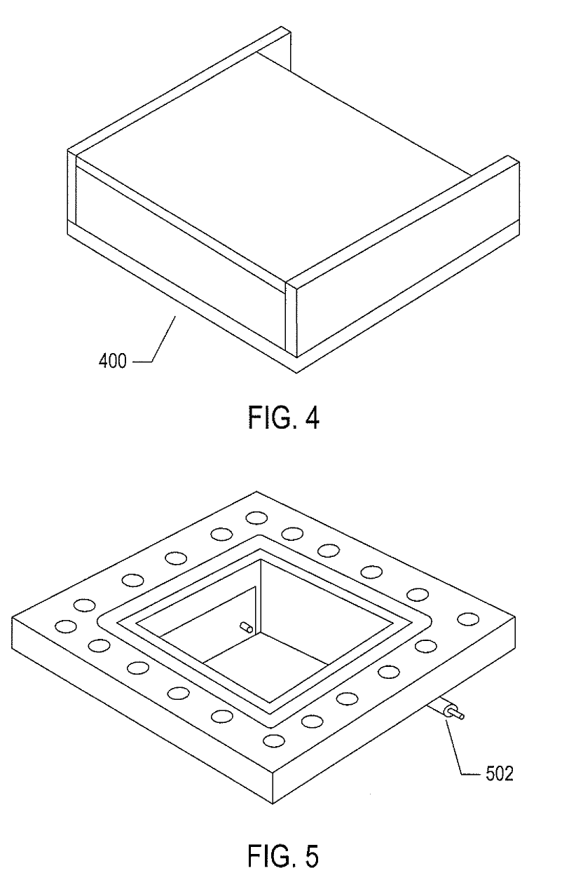

A completed stack 400 is shown in FIG. 4. Power to the bus bars is brought into the reactor housing through insulating feed-throughs 502, as shown in FIG. 5.

The length of the layers determines the reaction length of the core section. The current design is 4 inches long (10.16 mm). However, it may be beneficial to have a number of cores in series with shorter lengths. In additional examples, different reaction lengths are used.

### Core Details:

If desired, different core sections can be set up to operate at different temperatures by changing the diameter of the resistance wire or the type of resistance wire. The resistance per linear foot changes the temperature for a given power source.

The length of the individual core sections, be it one or many in series, is determined by the kinetics of the reaction. When the removal of heat energy from the side walls/catalyst is below the heat contributed by the heating elements to make the desired reaction go forward, then that location along the channel should be the length of the channel and core section. In other words, the length of the channel is governed by how much heat is removed from the catalyst heating element. Since various molecules have different heat capacities, this length can be calculated for a specific reaction and core length.

In some cases, the core length might be a certain length to produce a given reaction at a specific temperature. The output from that core section is then fed to another core section which has a different reaction temperature and core length or even a different catalyst. One or more additional reactants may be combined with the initial product before entering the second or even the third core section.

The wire gage/diameter and the length not only determine the length and wall temperatures, but also contribute to the physical channel geometry. This also determines the mass flow through the reactor channels.

The channel design is performed through a CHFD (Computational Fluid Dynamics) analysis. By calculating the entrance temperature of the reactor channel and then analyzing how much heat is removed from the walls and catalysts, the core section length can be determined. When the flow rate moves the mass past the end of a channel in a given time period, the reaction stops. The mass flow can be determined by CFD by again analyzing the physical dimensions of the channels for a given input flow rate and pressure.

### Housing:

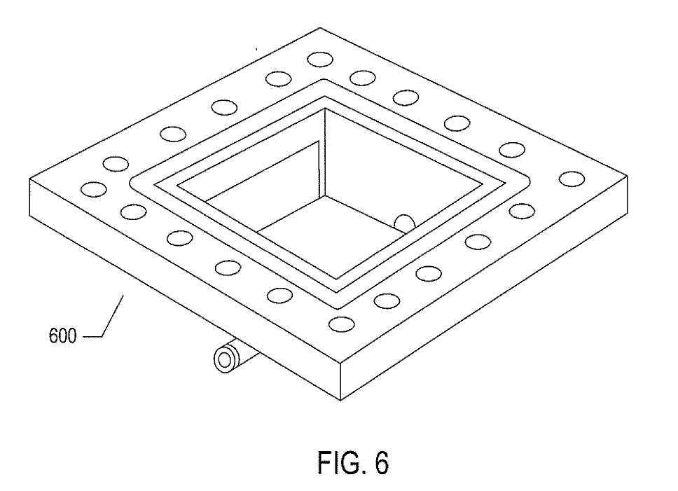

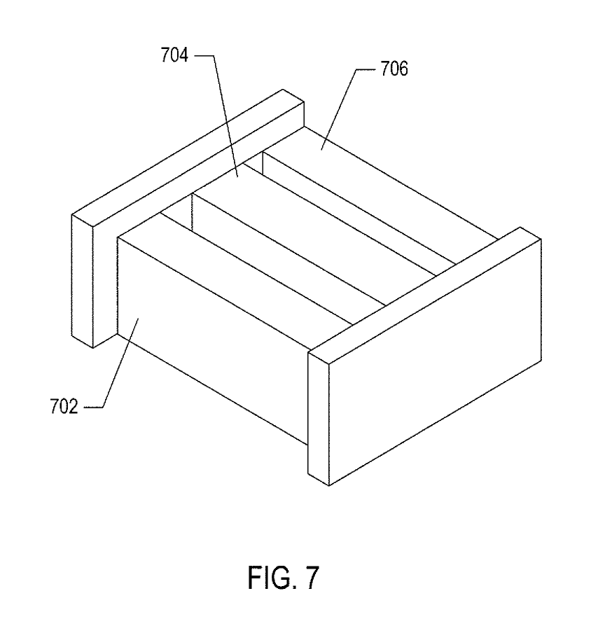

The housing of the Reactor 600 contains a single core, as in FIG. 6, or can contain a number of cores 702, 704, 706, as in FIG. 7. Multiple cores can be arranged so that a space and diffusion is formed between the cores. Within the diffusion area, the reacted material and hydrogen can be removed, leaving only the un-reacted material to enter another section of core material. The number and size of the cores can be repeated many times as desired.

Unreacted material enters one end of the housing as vapor through an appropriate connector. Reacted material and by products leave as vapor and gas at the other end through another connector. Attached to the outer surfaces of the housing are heaters that provide bulk heat to the reactor. In this design the heaters are attached through mechanical hardware.

### Temperature Sensing:

Thermocouples are placed at various locations within the reactor. The wires are fed though insulated feed-thoughs to the outside of the reactor and connected to controllers. The controllers determine when power should be applied to the heaters via PID loops or Fuzzy Logic.

Although the present invention has been described in terms of particular examples, it is not intended that the invention be limited to these examples. Modifications will be apparent to those skilled in the art. For example, a variety of different materials can be used for the various reactor components discussed above.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A micro-channel reactor comprising:
a plurality of wire-wound substrate plates stacked together within a reaction-chamber housing; and
an electrical connection that connects the wire of the wire-wound substrate plates to an external power source.
